(19) United States
(12) Patent Application Publication
(10) Pub. No.: US 2008/0203007 A1
(43) Pub. Date: Aug. 28, 2008

(54) PORTABLE WATER FILTRATION DEVICE

(76) Inventors: JAMES JANG, CYPRESS, CA (US); RICARDO JANG, CYPRESS, CA (US)

Correspondence Address: IPLA P.A., 3580 WILSHIRE BLVD., 17TH FLOOR, LOS ANGELES, CA, 90010, US

(21) Appl. No.: 11/840,578

(22) Filed: Aug. 17, 2007

(30) Foreign Application Priority Data
Feb. 22, 2007 (KR) 10-2007-0017854

(51) Int. Cl. B01D 24/00

(52) U.S. Cl. 210/348

(57) ABSTRACT

Disclosed is a portable water filtration device in which a filter cartridge having a water purifying function is mounted in a water bottle, including a body, which has an inlet in its upper portion and is made of an elastically deformable material, a lid, which is coupled with the body and has a discharge hole, through which water is discharged, a filter cartridge, which is coupled with the lid and has an outflow part from which the water is discharged, inflow holes through which the water enters, and a filter, and a filter housing, which is open in its upper portion for insertion of the filter cartridge into the filter housing. Thus, the portable water filtration device is easy to carry outdoors and is convenient to use because it does not require a separate pressurizer.

### CROSS REFERENCE

This application claims foreign priority under Paris Convention and 35 U.S.C. § 119 to Korean Patent Application No. 10-2007-0017854, filed Feb. 22, 2007 with the Korean Intellectual Property Office.

### BACKGROUND OF THE INVENTION

1. Field of the Invention

The present invention relates to a portable water filtration device in which a filter cartridge having a water purifying function is mounted in a water bottle, and, more particularly, to a portable water filtration device that is easy to carry outdoors and is convenient to use because it does not need to include a separate pressurizer.

2. Description of the Related Art

Generally, a water purifier is a mechanism that purifies water by straining out various foreign particles present in the water. Water purifiers have become a necessity in restaurants as well as in homes since environmental pollution problems have become serious and interest in health has increased.

Recently, interest in leisure activities such as fishing or climbing has increased along with improved living conditions, and thus interest in clean water is also rising. Accordingly, the demand for a water purifier increases and people want to drink purified water outdoors.

In addition, it is very important for military personnel to obtain good-quality water when performing outdoor operations.

However, when water is purified in advance and carried, its weight becomes a burden and there is a limit to the amount that can be carried. Moreover, in many cases, running water or water collected in nature cannot be drunk due to environmental pollution, which is getting worse.

As a result, a portable water purifier that can be easily used anywhere to filter water for drinking has been developed.

To filter water, the water is required to pass through the filter of a water purifier. A known portable water purifier has a problem in that it takes a long time to pass water through the filter. Moreover, a portable water purifier including a pressurizer that was developed to solve this problem also has a problem in that it is too large due to the addition of the pressurizer.

### SUMMARY OF THE INVENTION

The present invention aims to solve the above-mentioned problems, and an object of the invention is to provide a portable water purifier that is easy to carry outdoors and is convenient to use because it does not comprise a separate pressurizer.

To realize the above-mentioned object, the invention provides a portable water purifier, including a body that has an inlet in its upper portion and is made of an elastically deformable material, a lid that is coupled to the body and has a discharge hole through which water is discharged, a filter cartridge that is coupled to the lid and has an outflow part from which the water is discharged, inflow holes through which the water enters, and a filter, and a filter housing that is open in the upper portion thereof for insertion of the filter cartridge into the filter housing.

It is preferable that an air-check valve, for automatically blocking or controlling the inflow of external air, be further included in the body.

In addition, it is preferable that a gap in which water moves be defined between the filter cartridge and the filter housing, and it is further preferable that separating projections, which come into contact with the outer side of the filter cartridge and the inner side of the filter housing, be formed to define the gap.

It is further preferable that the filter housing have a size sufficient for insertion of the entire filter cartridge, and that the filter cartridge and the filter housing be separable from each other.

It is preferable that a filter coupling part be formed to be coupled with the filter cartridge in the inside of the lid so that the filter cartridge can be separated from the lid and replaced, and that the discharge hole can be opened and closed.

In addition, it is preferable that the filter further include a ceramic part for producing alkaline reducing water.

Grooves having a finger shape are formed on the outer side of the body.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is an exploded perspective view illustrating the configuration of a portable water purifier according to an embodiment of the invention.

FIG. 2 is a sectional view illustrating the configuration of the portable water purifier according to the embodiment of the invention.

FIG. 3 is a sectional view illustrating the state in which the portable water purifier according to the embodiment of the invention, containing a large amount of water, is used.

FIG. 4 is a sectional view illustrating the state in which the portable water purifier according to the embodiment of the invention, containing a small amount of water, is used.

### DETAILED DESCRIPTION OF THE INVENTION

Hereinafter, a preferred embodiment of the invention will be described in detail with reference to the accompanying drawings.

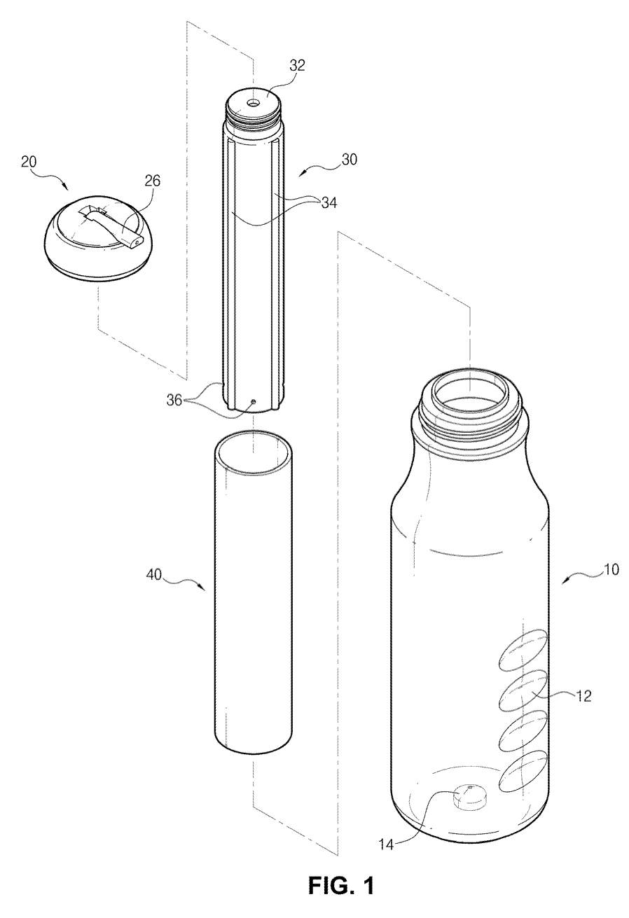

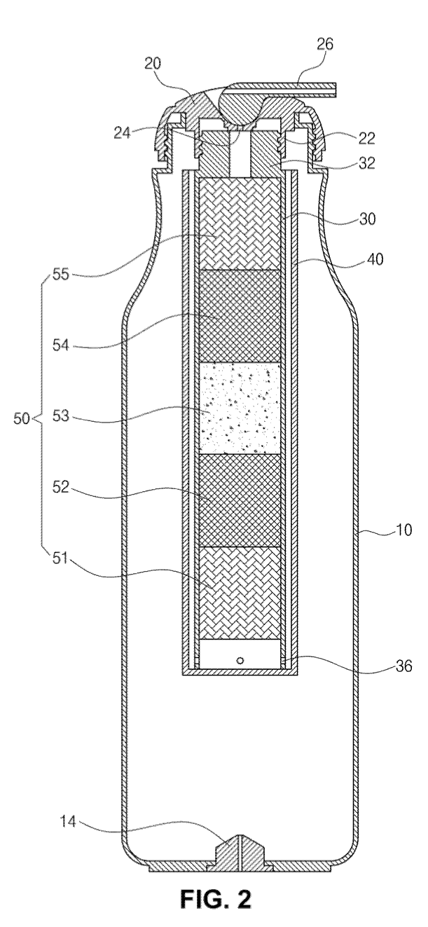

FIG. 1 is an exploded perspective view illustrating the configuration of a portable water purifier according to the embodiment of the invention, and FIG. 2 is a sectional view illustrating the configuration of the portable water purifier according to the embodiment of the invention.

The portable water purifier according to the embodiment has a body 10, a lid 20, a filter cartridge 30, and a filter housing 40.

The body 10 is a container for containing water. The body 10 has an inlet in the upper portion thereof, and a screw thread that can be coupled with the lid 20 is formed on the outer side of the inlet. Since the body 10 is made of a soft plastic material having elasticity, the body 10 is deformed when pressure is applied, and returns to its original shape when the pressure is removed. In addition, grooves 12 having a finger shape are formed on the outer side of the body 10 so that the body 10 can be easily held in the hand and so that a positive gripping sensation can be felt.

An air-check valve 14 is provided on the bottom of the body 10 to allow air to be introduced from the outside to the inside, but not from the inside to the outside. The air-check valve is configured so that a frame sheet and a thin film positioned thereon are disposed in a small cylindrical container. Accordingly, air is sucked only from the outside to the inside, and air flow is automatically blocked when the inside is filled with water or is pressurized.

A filter coupling part 22 is formed in the lower portion of the lid 20, and a discharge hole 24 is formed in the upper portion thereof. The filter coupling part 22 is a part that is coupled with the filter cartridge 30, and protrudes toward the inside of the lid 20. A screw thread is formed on the inner side of the filter coupling part 22. The discharge hole 24 is a part through which purified water is discharged, and is a through hole positioned in the center of the filter coupling part 22. A hollow tube 26 is rotatably coupled with an edge of the discharge hole 24 to open/close the discharge hole 24.

The filter cartridge 3 is a part that purifies water and is coupled with the lid 20. The filter cartridge 3 has a cylindrical shape, and includes an outflow part 32, separating projections 34 and inflow holes 36. A filter 50 is also included therein. The outflow part 32 is a part from which water, having passed through the filter, is discharged, and is positioned in the upper portion of the filter cartridge 30. A through hole is formed in the outflow part 32 to discharge water, and a screw thread is formed in the outer side of the outflow part 32 to be coupled with the filter coupling part 22 of the lid 20. The separating projections 34 function to define a separating space for the movement of water between the filter housing 40 and the filter cartridge 30. At least one of the separating projections 34 protrudes from the outer side of the filter cartridge 30. The inflow holes 36 are through holes through which water enters into the filter cartridge 30 to pass through the filter 50. At least one of the inflow holes 36 is formed in the lower portion of the filter cartridge 30.

The filter 50 is disposed inside the filter cartridge 30, and generally includes a sediment pre-filter 51, a pre-carbon filter 52, sand 53, a post carbon filter 54, and a post sediment filter 55 according to the water movement path. The configuration of the filter may be variously modified.

Particularly, when a ceramic part (not shown), which can be used to obtain mineral-rich alkaline reducing water, is included in the filter 50, functional water is effectively produced.

The filter housing 40 has a cylindrical shape with an open upper portion, and the filter cartridge 30 is inserted therein. The filter housing 40 has a size sufficient for insertion of the entire filter cartridge 30, and brings the separating projections 34 into close contact with the inner side of the filter housing 40. Since a gap is defined between the filter housing 40 and the filter cartridge 30 by the separating projections 34, water can move freely.

The operation of the portable water purifier according to the embodiment of the invention will be described below.

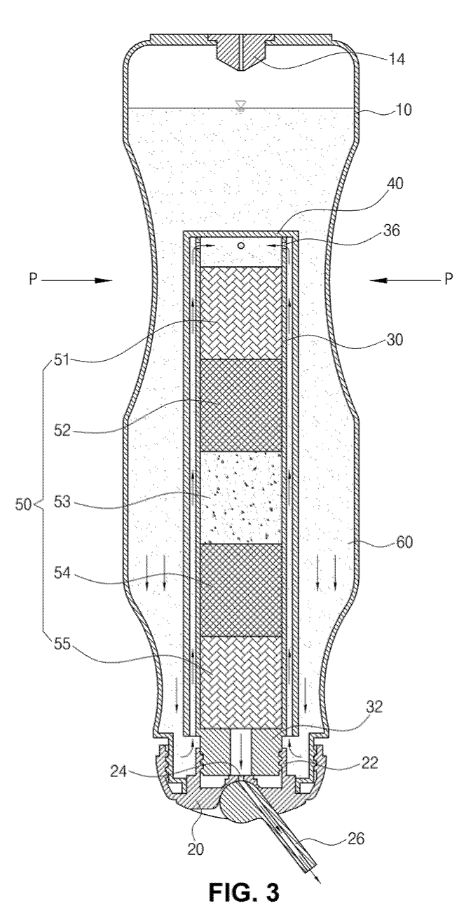

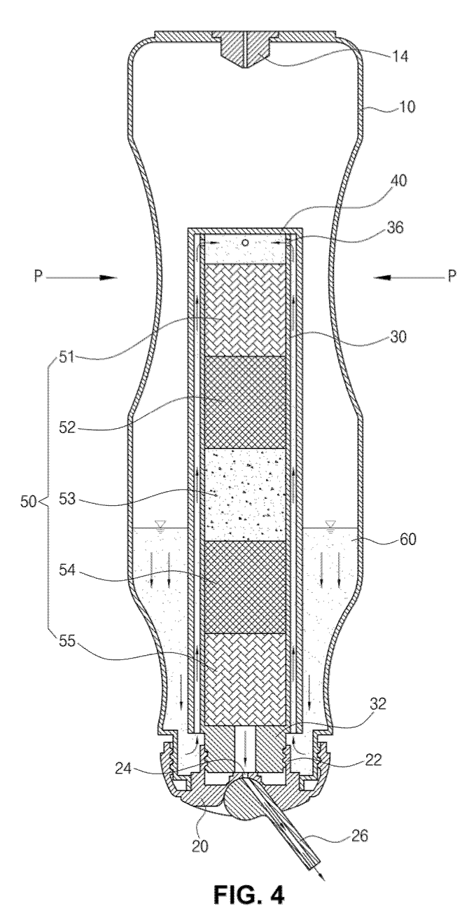

FIGS. 3 and 4 are sectional views illustrating states in which the portable water purifier according to the embodiment of the invention is used, and the arrows in the drawings indicate the direction of water movement.

Firstly, the filter cartridge 30 is inserted into the filter housing 40, and then the filter cartridge 30 is coupled with the lower portion of the lid 20.

The lid 20, the lower portion of which is coupled with the filter cartridge 30, is tightened to the body 10, which contains water 60.

The body 10 with the closed lid 20 is turned bottom up, the tube 26 of the lid 20 is rotated to match the hollow interior of the tube 26 with the discharge hole 24 and open the discharge hole 24, and then pressure P is applied by pressing the side of the body 10 with the hand.

Since the pressure is applied, the volume of the inside of the body 10 is reduced and the internal pressure increases. As a result, the pressure is applied to the water 60, and thus the water 60 is discharged through the opened discharge hole 24.

The water that flows out moves to the inside of the filter housing 40 through the gap between the filter housing 40 and the filter cartridge 30.

After that, the inside of the filter housing 40 is entirely filled with the water 60. Then, the water 60 flows into the inside of the filter cartridge 30 through the inflow holes 36 of the filter cartridge 30.

At this time, the filter housing 40 covers the entire filter cartridge 30. The space of the filter housing 40, into which the water flows, is at the lowest position when the body 10 is inverted. Thus, even if the amount of water 60 is small, the movement of water is not impeded.

The water 60 flowing into the inside of the filter cartridge 30 passes through the filter 50. After impurities have been filtered out, the water 60 is discharged through the discharge hole 24.

As described above, pressure is applied once and then purified water starts to be discharged. Then, when the pressure applied to the body is removed, the pressure inside the body 10 is reduced, while the body 10 is returned to its original shape from the deformed shape.

When the pressure inside the body 10 is lowered, the air-check valve 14 provided on the bottom of the body 10 is opened and external air is introduced into the body 10.

At this time, when the water level is higher than the inflow holes 36 of the filter cartridge 30, as shown in FIG. 3, the purified water is continuously discharged because of the weight of the water, even if no pressure is applied to the body 10.

Further, there is the case in which the flow of purified water is interrupted because the water level is lower than the position of the inflow holes 36 of the filter cartridge 30, as shown in FIG. 4, or the case in which people want to obtain purified water more rapidly. In these cases, when pressure is continuously applied to the body 10, purified water is continuously discharged.

When pressure is continuously applied, as described above, external air is introduced into the inside of the body 10 through the air-check valve 14 every time the pressure is removed. Accordingly, the body 10 is returned to its original shape at once, and pressure can be continuously applied to the body 10.

The portable water purifier according to the embodiment of the invention has the following advantages.

Firstly, a filter cartridge is mounted in the inside of a body, but no separate pressurizer is required. For operation, the portable water purifier need only be pressurized by hand. Moreover, the portable water purifier is easy to carry outdoors and can easily produce drinking water anywhere.

Secondly, since the entire filter cartridge is inserted into the filter housing, an inlet for sucking water is at the lowermost position at the time that the portable water purifier is used. Therefore, water can be entirely used, rather than remaining at the bottom.

Thirdly, since the filter cartridge is separably coupled to the lid, the filter cartridge is easily separated from the lid for replacement thereof.

Finally, an air-check valve is provided. Therefore, when the amount of water is large, purified water can be obtained without continuously applying pressure, and when the amount of water is small, water can be easily discharged by continuously applying pressure.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A portable water filtration device, comprising:
a body, which has an inlet in its upper portion and is made of an elastically deformable material;
a lid, which is coupled with the body and has a discharge hole, through which water is discharged;
a filter cartridge, which is coupled with the lid and has an outflow part from which the water is discharged, inflow holes through which the water enters, and a filter; and
a filter housing, which is open in its upper portion for insertion of the filter cartridge into the inside of the filter housing.

2. The portable water filtration device according to claim 1, further comprising an air-check valve for automatically blocking or controlling inflow of external air in the body.

3. The portable water filtration device according to claim 1, wherein a gap in which water moves is defined between the filter cartridge and the filter housing.

4. The portable water filtration device according to claim 3, wherein separating projections, which come into contact with an outer side of the filter cartridge and an inner side of the filter housing, are formed to define the a gap in which water moves between the filter cartridge and the filter housing.

5. The portable water filtration device according to claim 4, wherein the filter housing has a size sufficient for insertion of the entire filter cartridge, and the filter cartridge and the filter housing are separable from each other.

6. The portable water filtration device according to claim 4, wherein a filter coupling part is formed to be coupled with the filter cartridge in the inside of the lid so as to separate the filter cartridge from the lid for replacement, and the discharge hole can be opened and closed.

7. The portable water filtration device according to claim 4, wherein the filter further includes a ceramic part for producing alkaline reducing water.

8. The portable water filtration device according to claim 4, wherein grooves having a finger shape are formed in an outer side of the body.
